(19) United States
(12) Patent Application Publication
(10) Pub. No.: US 2015/0364832 A1
(43) Pub. Date: Dec. 17, 2015

(54) AN ANTENNA ARRANGEMENT AND A BASE STATION

(71) Applicant: CELLMAX TECHNOLOGIES AB, Kista (SE)

(72) Inventors: Dan KARLSSON, Sollentuna (SE); Stefan JONSSON, Sollentuna (SE); Pontus FORSMAN, Upplands Vasby (SE)

(73) Assignee: CELLMAX TECHNOLOGIES AB, Kista (SE)

(21) Appl. No.: 14/764,966

(22) PCT Filed: Jan. 16, 2014
(86) PCT No.: PCT/SE2014/050046

§ 371 Date: Jul. 30, 2015

(30) Foreign Application Priority Data
Jan. 31, 2013 (SE) 1350118-4

(51) Int. Cl. H01Q 21/00; H01Q 19/10

(52) U.S. Cl. CPC H01Q 21/0006; H01Q 19/10

(57) ABSTRACT

An antenna arrangement for mobile communication, the antenna arrangement comprising an antenna feeding network (202), the antenna feeding network comprising a plurality of air-filled coaxial lines (204) and at least one antenna feeding path, each antenna feeding path comprising at least one of the air-filled coaxial lines, each air-filled coaxial line having an inner conductor (206) and an outer conductor (208), wherein the antenna arrangement comprises an electrically conductive reflector (210) having a front side (212) and a backside (214), wherein the front side is arranged to receive a plurality of antenna element arrangements (802, 803) arranged to be placed on the front side, each antenna element arrangement comprising at least one electrically conductive antenna element connectable to at least one of the air-filled coaxial lines, wherein a first group (216) of the plurality of air-filled coaxial lines is located at the backside of the reflector between a first plane (218), in which the front side or backside lies, and a second plane (220) parallel to the first plane, and wherein a second group (222) of the plurality of air-filled coaxial lines is located outside of the region (224) between the first and the second plane.

### TECHNICAL FIELD

The present invention relates to an antenna arrangement for mobile communication. The antenna arrangement comprises an antenna feeding network, the antenna feeding network comprising a plurality of air-filled coaxial lines and at least one antenna feeding path. Each antenna feeding path comprises at least one of the air-filled coaxial lines, and each air-filled coaxial line has an inner conductor and an outer conductor. The antenna arrangement comprises an electrically conductive reflector having a front side and a backside, wherein the front side is arranged to receive a plurality of antenna element arrangements arranged to be placed on the front side. Each antenna element arrangement comprises at least one electrically conductive antenna element connectable to at least one of the air-filled coaxial lines.

### BACKGROUND OF THE INVENTION

A typical communications antenna arrangement may comprise a plurality of radiating antenna elements, an antenna feeding network and a reflector. The radiators are typically arranged in columns, each column of radiators forming one antenna. The radiators may by single or dual polarized; in the latter case, two feeding networks are needed per antenna, one for each polarization. Radiators are commonly placed as an array on the reflector, in most cases as a one-dimensional array extending in the vertical plane, but also two-dimensional arrays are used. For the sake of simplicity, only one-dimensional arrays are considered below, but this should not be considered as limiting the scope of this patent. The radiating performance of an antenna is limited by its aperture, the aperture being defined as the effective antenna area perpendicular to the received or transmitted signal. The antenna gain and lobe widths are directly related to the antenna aperture and the operating frequency. As an example, when the frequency is doubled, the wavelength is reduced to half, and for the same aperture, gain is doubled, and lobe width is halved. For the array to perform properly, the radiators are usually separated by a distance which is a slightly less than the wavelength at which they operate, hence the gain will be proportional to the number of radiators used, and the lobe width inversely proportional to the number of radiators.

With the proliferation of cellular systems (GSM, DCS, UMTS, LTE, WiMAX, etc.) and different frequency bands (700 MHz, 800 MHz, 900 MHz, 1800 MHz, 1900 MHz, 2600 MHz, etc.) it has become advantageous to re-group antennas for different cellular systems and different frequency bands into one multiband antenna. A common solution is to have a Low Band Antenna (e.g. GSM 800 or GSM 900) combined with one or more High Band Antennas (e.g. DCS 1800, PCS 1900 or UMTS 2100). Frequency bands being made available more recently, such as the 2600 MHz band can also be included in a multiband antenna arrangement.

The Low Band Antenna is commonly used to achieve best cell coverage, and it is essential that the gain is as high as possible. The High Band Antennas are used to add another frequency band for increased capacity, and the gain has until recently not been optimised, the tendency has been to keep similar vertical lobe widths for both bands resulting in a smaller aperture for the High Band Antenna compared with the aperture of the Low Band Antenna, typically about half that of the Low Band Antenna. This has also allowed for e.g. two High Band Antennas 115 to be stacked one above the other beside a Low Band Antenna 116 in a side-by-side configuration. These two antennas can be used for two different frequency bands (e.g. PCS 1900 and UMTS 2100 or LTE 2600). Another configuration which is used is the interleaved antenna. In this configuration dual band radiating elements 113 which consist of a combined Low Band radiator and a High Band radiator as described in WO2006/058658-A1 are used, together with single band Low Band 111 and High Band radiators 112.

When having a plurality of antenna elements, a signal needs to be split between the antenna elements in a transmission case, and combined from the antenna elements in a reception case. Reference is made to FIG. 1 to illustrate the splitting and combination in an antenna feeding network. The signal splitting and the signal combination are usually effected using the same antenna feeding network, which is reciprocal, and splitters and combiners may be used.

WO2005/101566-A1 discloses an antenna feeding network including at least one antenna feeding line, each antenna feeding line comprising a coaxial line having an inner conductor and a surrounding outer conductor. The outer conductor is made of an elongated tubular compartment having an elongated opening along one side of the compartment, and the inner conductor is suspended within the tubular compartment by means of dielectric support means.

WO2009/041896-A1 describes an antenna arrangement for a multi-radiator base station antenna, the antenna having a feeding network based on air-filled coaxial lines, wherein each coaxial line comprises an outer conductor and an inner conductor. An adjustable differential phase shifter including a dielectric part is arranged in the antenna, and the dielectric part is movable longitudinally in relation to at least one coaxial line.

### SUMMARY OF THE INVENTION

The inventors of the present invention have identified the need for multiband base station antennas which incorporate low loss feeding networks, but state of the art low loss feeding networks increases the size of such antennas. Antenna size is important for important for operators, both in terms of leasing costs for towers or other spaces for locating the antennas, and because of the visual impact it has on the public.

The object of the present invention is thus to provide a less bulky base station antenna.

Another object of the present invention is to provide a less costly base station arrangement.

The above-mentioned object of the present invention is attained by providing an antenna arrangement for mobile communication, the antenna arrangement comprising an antenna feeding network. The antenna feeding network comprises a plurality of air-filled coaxial lines and at least one antenna feeding path. Each antenna feeding path comprises at least one of the air-filled coaxial lines, each air-filled coaxial line having an inner conductor and an outer conductor. The antenna arrangement comprises an electrically conductive reflector having a front side and a backside, wherein the front side is arranged to receive a plurality of antenna element arrangements arranged to be placed on the front side. Each antenna element arrangement comprises at least one electrically conductive antenna element connectable to at least one of the air-filled coaxial lines. A first group of the plurality of air-filled coaxial lines is located at the backside of the reflector between a first plane, in which the front side or backside lies, and a second plane parallel to the first plane. A second group of the plurality of air-filled coaxial lines is located outside of the region between the first plane and the second plane.

By means of the antenna arrangement according to the present invention, the width of the base station antenna, including the reflector, is reduced, and a less bulky base station antenna and a less costly base station arrangement are provided. By arranging the air-filled coaxial lines at two different levels in relation to the plane of the backside of the reflector, the structure of the antenna arrangement is also made more rigid.

According to an advantageous embodiment of the antenna arrangement according to the present invention, at least one of the air-filled coaxial lines of the first group may be connectable or connected, directly or indirectly, to at least one of the at least one electrically conductive antenna element,

According to a further advantageous embodiment of the antenna arrangement according to the present invention, at least one of the air-filled coaxial lines of the second group may be connectable or connected, directly or indirectly, to at least one of the at least one electrically conductive antenna element.

Each inner conductor may be suspended within the outer conductor by means of at least one dielectric support member.

According to an advantageous embodiment of the antenna arrangement according to the present invention, the inner conductor of at least one of the air-filled coaxial lines of the first group is connected to the inner conductor of at least one of the air-filled coaxial lines of the second group.

According to a further advantageous embodiment of the antenna arrangement according to the present invention, the inner conductor of at least one of the air-filled coaxial lines of the first group is connected to the inner conductor of at least one of the air-filled coaxial lines of the second group via an opening or passage in the outer conductor/-s of the air-filled coaxial lines having their inner conductors connected to one another.

According to another advantageous embodiment of the antenna arrangement according to the present invention, the inner conductor of at least one of the air-filled coaxial lines of the first group is connected to the inner conductor of at least one of the air-filled coaxial lines of the second group by means of a crossing or transition device arranged to connect the two inner conductors to one another.

According to yet another advantageous embodiment of the antenna arrangement according to the present invention, the crossing or transition device comprises a conductor arranged to connect the two inner conductors to one another.

According to an advantageous embodiment of the antenna arrangement according to the present invention, the second group is located at the backside of the reflector between the second plane and a third plane parallel to the first and second planes.

According to a further advantageous embodiment of the antenna arrangement according to the present invention, a third group of the plurality of air-filled coaxial lines is located outside of the region between the first and second planes and located outside of the region between the second plane and the third plane.

According to another advantageous embodiment of the antenna arrangement according to the present invention, the air-filled coaxial lines of the first group are parallel to one another.

According to an advantageous embodiment of the antenna arrangement according to the present invention, the air-filled coaxial lines of the second group are parallel to one another.

According to yet another advantageous embodiment of the antenna arrangement according to the present invention, the air-filled coaxial lines of the plurality of air-filled coaxial lines are parallel to one another.

According to an advantageous embodiment of the antenna arrangement according to the present invention, the outer conductor forms an elongated tubular compartment, and the inner conductor extends within the tubular compartment.

According to a further advantageous embodiment of the antenna arrangement according to the present invention, the tubular compartment is of square cross-section. However, other cross-sections are possible. The tubular compartments of the plurality of air-filled coaxial lines and the reflector together may form a self-supporting framework.

According to another advantageous embodiment of the antenna arrangement according to the present invention, at least some of the air-filled coaxial lines of the first group and at least some of the air-filled coaxial lines of the second group are integral with one another.

According to yet another advantageous embodiment of the antenna arrangement according to the present invention, an adjustable differential phase shifter including a dielectric member is arranged in the first group and/or the second group and/or the third group of the plurality of air-filled coaxial lines, and in that the dielectric member is movable in relation to the air-filled coaxial lines, for example arranged to be guided by the outer conductor.

According to an advantageous embodiment of the antenna arrangement according to the present invention, the at least one electrically conductive antenna element is connected, directly or indirectly, to at least one of the air-filled coaxial lines of the first group and/or the at least one electrically conductive antenna element is connected, directly or indirectly, to at least one of the air-filled coaxial lines of the second group.

The above-mentioned object of the present invention is attained by providing a base station for mobile communication, wherein the base station comprises at least one antenna arrangement as claimed in any of the claims 1 to 18, or at least one antenna arrangement according to any of the other disclosed embodiments of the antenna arrangement.

The above-mentioned features and embodiments of the antenna arrangement may be combined in various possible ways providing further advantageous embodiments.

Further advantageous embodiments of the device according to the present invention and further advantages with the present invention emerge from the dependent claims and the detailed description of embodiments.

### BRIEF DESCRIPTION OF THE DRAWINGS

The present invention will now be described, for exemplary purposes, in more detail by way of embodiments and with reference to the enclosed drawings, in which:

FIG. 1 is a schematic view of an antenna feeding network;

FIG. 2a is a schematic cross-section view of a first embodiment of the coaxial line of the antenna feeding network;

FIG. 2b is a schematic longitudinal cross-section view of the first embodiment of the coaxial line of the antenna feeding network;

FIG. 3a is a schematic cross-section view of a second embodiment of the coaxial line of the antenna feeding network;

FIG. 3b is a schematic longitudinal cross-section view of the second embodiment of the coaxial line of the antenna feeding network;

FIG. 4 is a schematic perspective view of an embodiment of the antenna arrangement according to the present invention;

FIG. 5 is a schematic partial cross-section view of an embodiment of the antenna arrangement according to the present invention;

FIG. 6 is a schematic perspective view of an embodiment of a crossing or transition device included in an embodiment the antenna arrangement according to the present invention;

FIGS. 7-8 are schematic top views illustrating a plurality of embodiments the reflector provided with a plurality of embodiments of the antenna element arrangement;

FIG. 9 is a schematic side view of an embodiment the reflector provided with a plurality of embodiments of the antenna element arrangement; and

FIGS. 10-11 are schematic perspective views of embodiments of the antenna element arrangement.

### DETAILED DESCRIPTION OF EMBODIMENTS

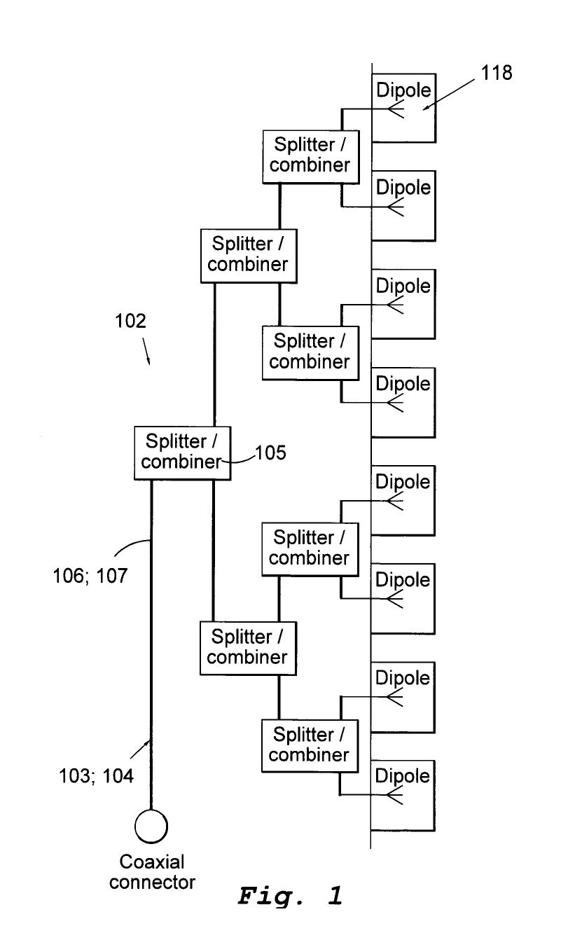

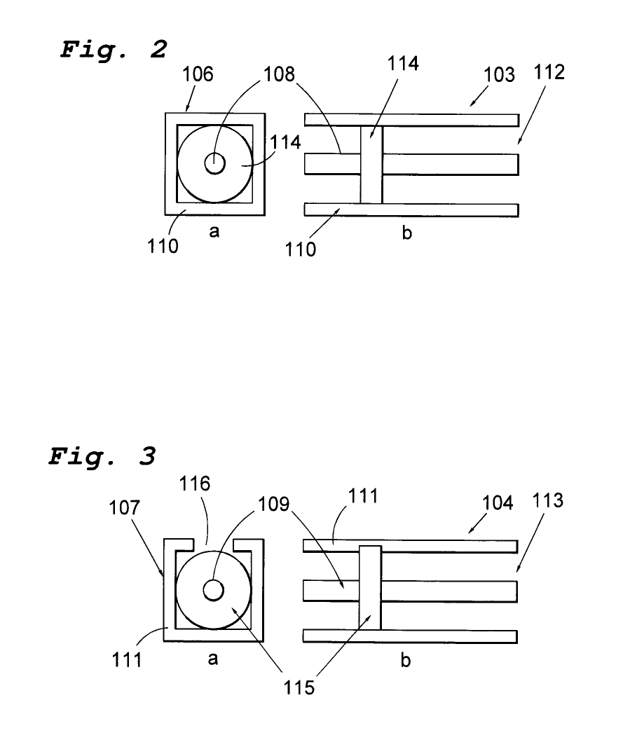

FIGS. 1-3 schematically show aspects of the antenna arrangement according to the present invention, comprising an antenna feeding network 102. The antenna feeding network 102 comprises at least one antenna feeding path 103; 104. In FIG. 1, a plurality of antenna feeding paths 103; 104 are shown. Each antenna feeding path 103; 104 is a path along which a signal may be fed. Each antenna feeding path 103; 104 comprises at least one transmission line, also called feeding line, represented by the thicker lines. Each antenna feeding path 103; 104 may also comprise a splitter/combiner 105. Each transmission line may be in the form of a coaxial line 106, 107, e.g. an air-filled coaxial line. Each coaxial line 106, 107 comprises an inner electrical conductor 108, 109 and an outer electrical conductor 110, 111, which may surround, at least partially, the inner conductor 108, 109. The inner conductor 108, 109 may be central in relation to the outer conductor 110, 111, or may be radially displaced in relation to the outer conductor. The outer conductor 110, 111 may form an elongated tubular compartment 112, 113 and the inner conductor 108, 109 may extend within the tubular compartment 112, 113. The tubular compartment 112, 113 may be of square cross-section, but other cross-sections such as rectangular, circular or ellipsoidal are possible. One or more support members 114, 115 may be provided to suspend the inner conductor 108; 109 within the outer conductor 110, 111. Each support member 114, 115 may be made of a dielectric material. The material of the support member 114, 115 may be a polymer, such as PTFE. With reference to FIG. 3a, the elongated tubular compartment 113 may have an elongated opening 116 along one side of the compartment 113. With reference to FIG. 1, the antenna arrangement may comprise a plurality of antenna element arrangements 118. Each antenna element arrangement 118 may comprise at least one electrically conductive antenna element connectable to at least one of the air-filled coaxial lines. The antenna element may be a radiating antenna element, e.g. a dipole. However, other sorts of radiating antenna elements are possible.

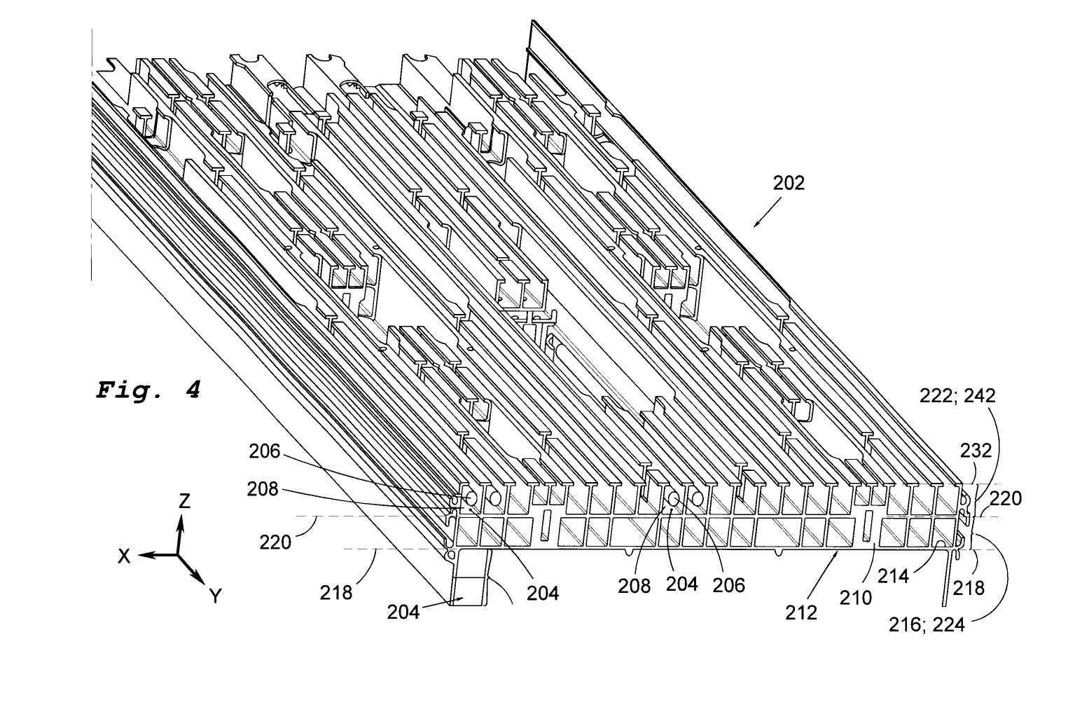

FIG. 4 schematically shows an embodiment of the antenna arrangement for mobile communication according to the present invention. The antenna arrangement comprises an antenna feeding network 202. The antenna feeding network 202 comprises a plurality of air-filled coaxial lines 204 and at least one antenna feeding path 103; 104 (see FIG. 1). Each antenna feeding path comprises at least one of the air-filled coaxial lines 204. Each air-filled coaxial line 204 has an inner conductor 206 and an outer conductor 208. The antenna arrangement comprises an electrically conductive reflector 210 having a front side 212 and a backside 214. In FIG. 4, the front side 212 is downwards and the backside 214 is upwards. In general, when the antenna arrangement is part of a base station, the reflector 210 extends substantially vertically. However, other orientations are possible. The front side 212 is arranged to receive a plurality of antenna element arrangements 802, 832 (see FIGS. 7-10) arranged to be placed on the front side 212. The antenna arrangement may comprise the antenna element arrangements. The antenna element arrangements may be attached or mounted to the reflector 210. The front side 212 may act as a reflecting plane for the radiating elements. The reflector 210 may be formed of a conductive sheet, e.g. a sheet or plate of metal.

Each antenna element arrangement comprises at least one electrically conductive antenna element connectable to at least one of the air-filled coaxial lines 204. In alternative words, at least one of the air-filled coaxial lines 204 may be connectable or connected, directly or indirectly, to at least one of the at least one electrically conductive antenna element.

Each electrically conductive antenna element may be defined as a radiating antenna element or as a radiator, and may e.g. be a dipole. Alternatively, each antenna element arrangement may be defined as a radiator. However, other antenna elements are possible. A first group 216 of the plurality of air-filled coaxial lines 204 is located at the backside of the reflector 210 between a first plane 218, in which the front side or backside 214 lies, and a second plane 220, the second plane 220 being parallel to the first plane 218. A second group 222 of the plurality of air-filled coaxial lines 204 is located outside of the region 224 between the first plane 218 and the second plane 220.

At least one of the air-filled coaxial lines 204 of the first group 218 may be connectable or connected, directly or indirectly, to at least one of the at least one electrically conductive antenna element, or to at least one antenna element arrangement. At least one of the air-filled coaxial lines 204 of the second group 222 may be connectable or connected, directly or indirectly, to at least one of the at least one electrically conductive antenna element, or to at least one antenna element arrangement. The at least one electrically conductive antenna element may be connected, directly or indirectly, to at least one of the air-filled coaxial lines 204 of the first group 218 and/or the at least one electrically conductive antenna element may be connected, directly or indirectly, to at least one of the air-filled coaxial lines 204 of the second group 222.

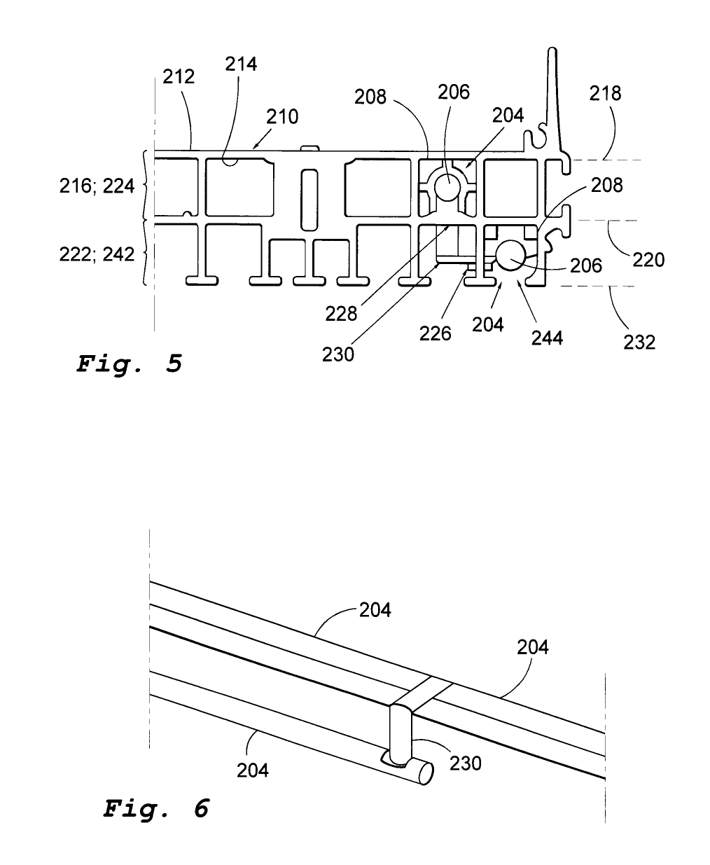

With reference to FIGS. 5 and 6, illustrating sections of the antenna arrangement, where the outer conductor in FIG. 6 is removed for illustrative purposes, the inner conductor 206 of at least one of the air-filled coaxial lines 204 of the first group may be connected to the inner conductor 206 of at least one of the air-filled coaxial lines 204 of the second group 222. The inner conductor 206 of at least one of the air-filled coaxial lines 204 of the first group may be connected to the inner conductor 206 of at least one of the air-filled coaxial lines 204 of the second group 222 via at least one opening or passage 226, 228 in the outer conductor/-s of the air-filled coaxial lines 204 having their inner conductors 206 connected to one another. The inner conductor 206 of at least one of the air-filled coaxial lines 204 of the first group may be connected to the inner conductor 206 of at least one of the air-filled coaxial lines 204 of the second group 222 by means of a crossing or transition device 230 arranged to connect the two inner conductors 206 to one another. The crossing or transition device 230 may comprise a conductor arranged to connect the two inner conductors 204 to one another. However, the crossing or transition device 230 may have other designs. The second group 222 may be located at the backside of the reflector 210 between the second plane 220 and a third plane 232, the third plane 232 being parallel to the first plane 218 and to the second plane 220.

With reference to FIG. 4, a third group 240 of the plurality of air-filled coaxial lines 204 may be located outside of the region 224 between the first and second planes 218, 220 and located outside of the region 242 between the second and third planes 220, 232. However, the antenna arrangement may be without said third group.

The air-filled coaxial lines 204 of the first group 216 may be parallel to one another. The air-filled coaxial lines 204 of the second group 222 may be parallel to one another. All of the air-filled coaxial lines 204 of the plurality of air-filled coaxial lines 204 may be parallel to one another.

The outer conductor 208 may form an elongated tubular compartment 244, and the inner conductor 204 may extend within the tubular compartment 244. The tubular compartment 244 may be of square cross-section. However, other cross-sections are possible as stated above. The tubular compartments 244 of the plurality of air-filled coaxial lines 204 and the reflector 210 may together form a self-supporting framework. At least some of the air-filled coaxial lines 204 of the first group 216 and at least some of the air-filled coaxial lines 204 of the second group 222 may be integral with one another, whereby a rigid structure is attained.

An adjustable differential phase shifter including a dielectric member may be arranged in the first group 216 and/or in the second group 222 and/or in the third group 240 of the plurality of air-filled coaxial lines 204. The dielectric member is movable in relation to the air-filled coaxial lines 204, for example arranged to be guided by the outer conductor 208. Reference is made to the applicant's application WO 2009/041896, which is herewith incorporated by reference, for further details on the differential phase shifter.

The antenna arrangement may comprise a connector, the connector being connectable to an external network. Each antenna element arrangement or antenna element may be connected to the connector via the antenna feeding network.

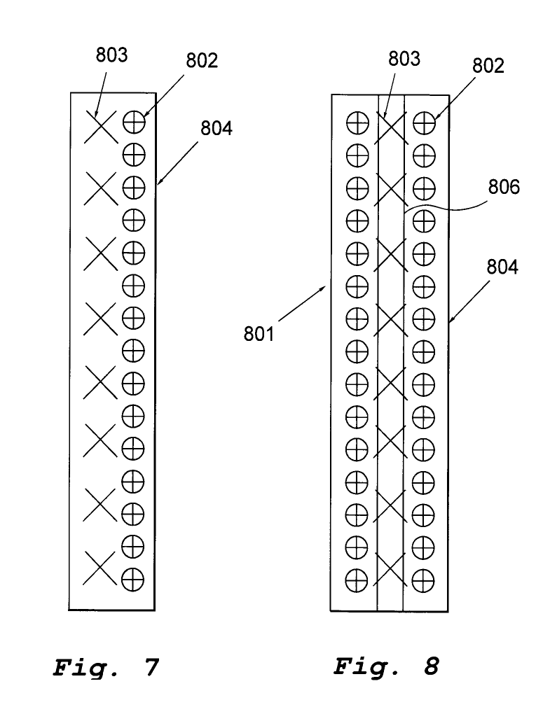

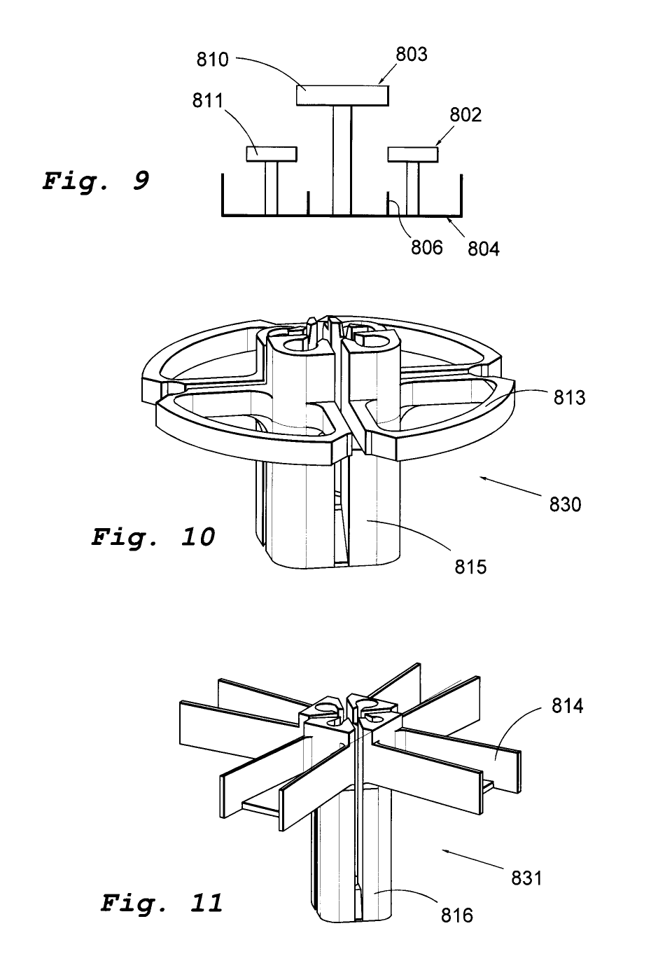

FIGS. 7-9 schematically show aspects of embodiments of antenna arrangements according to present invention, comprising a reflector 804 and antenna element arrangements 802, 803, each comprise at least one electrically conductive antenna element. The antenna element, or the antenna element arrangement, may be called a radiator. In FIG. 7, a first column of Low Band radiators 803 may be placed on a reflector 804. A second column of High Band radiators 802 may be placed next to the first column. The High Band radiators 802 may be smaller than the Low Band radiators 803, and the separation between radiators may be smaller than for the Low Band radiators, hence more High Band radiators are needed in order to occupy the full height of the reflector. In FIG. 8, a first column of Low Band radiators 803 may be placed in the middle of the reflector 804. A second column of High Band radiators 802 may be placed to one side of the first column, and a third column of High Band radiators 802 may be placed on the other side of the other side of the first column. All three columns may occupy the full height of the reflector 804. FIG. 9 shows a schematic side view of an embodiment of the antenna arrangement according to present invention. Low Band dipole 810 of Low Band radiator 803 may be located approximately a quarter wavelength, in relation to the Low Band, from the reflector 804, and High band dipole 811 may be located approximately a quarter wavelength, in relation to the High Band, from the reflector 804. It can be seen that the Low Band dipole 810 may extend above the High Band dipole 811, and it is therefore advantageous to use a Low Band dipole which extends as little as possible over the High Band dipole in order to reduce the impact of the Low Band dipole on the High Band radiation characteristics. A ridge 806 may be placed between the High Band radiators and the Low Band radiators in order to reduce coupling between bands, and reduce the azimuth beamwidth of the Low Band and High Band lobes. FIG. 10 shows an embodiment of a High Band four-clover leaf type dipole radiator 830. It consists of four essentially identical dipole halves 813. Two opposing dipole halves 813 form one first dipole. The other two opposing dipole halves 813 form a second dipole which has a polarization which is orthogonal to the first dipole. The dipole support 815 positions the dipoles at approximately a quarter wavelength from the reflector, and is also used to form two baluns, one for each dipole half. FIG. 11 shows an embodiment of a Low Band cross type dipole 831. It consists of four essentially identical dipole halves 814. Two opposing dipole halves 814 form one first dipole. The other two opposing dipole halves 814 form a second dipole which has a polarization which is orthogonal to the first dipole. The dipole support 816 positions the dipoles at approximately a quarter wavelength from the reflector, and is also used to form two baluns, one for each dipole.

However, other antenna element arrangements may be used for the antenna arrangement and may be positioned in other manners on the reflector. All of the antenna element arrangements may be identical instead of being different in design.

The features of the different embodiments of the antenna arrangement disclosed above may be combined in various possible ways providing further advantageous embodiments.

The invention shall not be considered limited to the embodiments illustrated, but can be modified and altered in many ways by one skilled in the art, without departing from the scope of the appended claims.

1. An antenna arrangement for mobile communication, the antenna arrangement comprising an antenna feeding network, the antenna feeding network comprising a plurality of air-filled coaxial lines and at least one antenna feeding path, each antenna feeding path comprising at least one of the air-filled coaxial lines, each air-filled coaxial line having an inner conductor and an outer conductor, wherein the antenna arrangement comprises an electrically conductive reflector having a front side and a backside, wherein the front side is arranged to receive a plurality of antenna element arrangements arranged to be placed on the front side, each antenna element arrangement comprising at least one electrically conductive antenna element connectable to at least one of the air-filled coaxial lines, wherein a first group of the plurality of air-filled coaxial lines is located at the backside of the reflector between a first plane, in which the front side or backside lies, and a second plane parallel to the first plane, and wherein a second group of the plurality of air-filled coaxial lines is located outside of the region between the first plane and the second plane.

2. The antenna arrangement according to claim 1, wherein the first group and the second group, respectively, comprise a plurality of air-filled of coaxial lines.

3. The antenna arrangement according to claim 1, wherein the at least one of the air-filled coaxial lines of the first group is connectable or connected, directly or indirectly, to at least one of the at least one electrically conductive antenna element.

4. The antenna arrangement according to claim 1, wherein at least one of the air-filled coaxial lines of the second group is connectable or connected, directly or indirectly, to at least one of the at least one electrically conductive antenna element.

5. The antenna arrangement according to claim 1, wherein the inner conductor of at least one of the air-filled coaxial lines of the first group is connected to the inner conductor of at least one of the air-filled coaxial lines of the second group.

6. The antenna arrangement according to claim 5, wherein the inner conductor of at least one of the air-filled coaxial lines of the first group is connected to the inner conductor of at least one of the air-filled coaxial lines of the second group via an opening or passage in the outer conductors of the air-filled coaxial lines having their inner conductors connected to one another.

7. The antenna arrangement according to claim 5, wherein the inner conductor of at least one of the air-filled coaxial lines of the first group is connected to the inner conductor of at least one of the air-filled coaxial lines of the second group by means of a crossing or transition device arranged to connect the two inner conductors to one another.

8. The antenna arrangement according to claim 7, wherein the crossing or transition device comprises a conductor arranged to connect the two inner conductors to one another.

9. The antenna arrangement according to claim 1, wherein the second group is located at the backside of the reflector between the second plane and a third plane parallel to the first and second planes.

10. The antenna arrangement according to claim 9, wherein a third group of the plurality of air-filled coaxial lines is located outside of the region between the first and second planes and located outside of the region between the second plane and the third plane.

11. The antenna arrangement according to claim 1, wherein the air-filled coaxial lines of the first group are parallel to one another.

12. The antenna arrangement according to claim 1, wherein the air-filled coaxial lines of the second group are parallel to one another.

13. The antenna arrangement according to claim 1, wherein the air-filled coaxial lines of the plurality of air-filled coaxial lines are parallel to one another.

14. The antenna arrangement according to claim 1, wherein the outer conductor forms an elongated tubular compartment, and in that the inner conductor extends within the tubular compartment.

15. The antenna arrangement according to claim 14, wherein the tubular compartment is of square cross-section.

16. The antenna arrangement according to claim 14, wherein the tubular compartments of the plurality of air-filled coaxial lines and the reflector together form a self-supporting framework.

17. The antenna arrangement according to claim 1, wherein at least some of the air-filled coaxial lines of the first group and at least some of the air-filled coaxial lines of the second group are integral with one another.

18. The antenna arrangement according to claim 1, wherein an adjustable differential phase shifter including a dielectric member is arranged in the first group or the second group of the plurality of air-filled coaxial lines, and in that the dielectric member is movable in relation to the air-filled coaxial lines, for example arranged to be guided by the outer conductor.

19. The antenna arrangement according to claim 1, wherein the at least one electrically conductive antenna element is connected, directly or indirectly, to at least one of the air-filled coaxial lines of the first group and/or the at least one electrically conductive antenna element is connected, directly or indirectly, to at least one of the air-filled coaxial lines of the second group.

20. A base station for mobile communication, wherein the base station comprises an antenna arrangement having an antenna feeding network, the antenna feeding network comprising a plurality of air-filled coaxial lines and at least one antenna feeding path, each antenna feeding path comprising at least one of the air-filled coaxial lines, each air-filled coaxial line having an inner conductor and an outer conductor, wherein the antenna arrangement comprises an electrically conductive reflector having a front side and a backside, wherein the front side is arranged to receive a plurality of antenna element arrangements arranged to be placed on the front side, each antenna element arrangement comprising at least one electrically conductive antenna element connectable to at least one of the air-filled coaxial lines, wherein a first group of the plurality of air-filled coaxial lines is located at the backside of the reflector between a first plane, in which the front side or backside lies, and a second plane parallel to the first plane, and wherein a second group of the plurality of air-filled coaxial lines is located outside of the region between the first plane and the second plane.

21. The base station according to claim 20, wherein the first group and the second group, respectively, comprise a plurality of air-filled of coaxial lines.

22. The base station according to claim 20, wherein the at least one of the air-filled coaxial lines of the first group is connectable or connected, directly or indirectly, to at least one of the at least one electrically conductive antenna element.

23. The base station according to claim 20, wherein at least one of the air-filled coaxial lines of the second group is connectable or connected, directly or indirectly, to at least one of the at least one electrically conductive antenna element.

24. The base station according to claim 20, wherein the inner conductor of at least one of the air-filled coaxial lines of the first group is connected to the inner conductor of at least one of the air-filled coaxial lines of the second group.

25. The base station according to claim 24, wherein the inner conductor of at least one of the air-filled coaxial lines of the first group is connected to the inner conductor of at least one of the air-filled coaxial lines of the second group via an opening or passage in the outer conductors of the air-filled coaxial lines having their inner conductors connected to one another.

26. The base station according to claim 24, wherein the inner conductor of at least one of the air-filled coaxial lines of the first group is connected to the inner conductor of at least one of the air-filled coaxial lines of the second group by means of a crossing or transition device arranged to connect the two inner conductors to one another.

27. The base station according to claim 26, wherein the crossing or transition device comprises a conductor arranged to connect the two inner conductors to one another.

28. The base station according to claim 20, wherein the second group is located at the backside of the reflector between the second plane and a third plane parallel to the first and second planes.

29. The base station according to claim 28, wherein a third group of the plurality of air-filled coaxial lines is located outside of the region between the first and second planes and located outside of the region between the second plane and the third plane.

30. The base station according to claim 20, wherein the air-filled coaxial lines of the first group are parallel to one another.

31. The base station according to claim 20, wherein the air-filled coaxial lines of the second group are parallel to one another.

32. The base station according to claim 20, wherein the air-filled coaxial lines of the plurality of air-filled coaxial lines are parallel to one another.

33. The base station according to claim 20, wherein the outer conductor forms an elongated tubular compartment, and in that the inner conductor extends within the tubular compartment.

34. The base station according to claim 33, wherein the tubular compartment is of square cross-section.

35. The base station according to claim 33, wherein the tubular compartments of the plurality of air-filled coaxial lines and the reflector together form a self-supporting framework.

36. The base station according to claim 20, wherein at least some of the air-filled coaxial lines of the first group and at least some of the air-filled coaxial lines of the second group are integral with one another.

37. The base station according to claim 20, wherein an adjustable differential phase shifter including a dielectric member is arranged in the first group or the second group of the plurality of air-filled coaxial lines, and in that the dielectric member is movable in relation to the air-filled coaxial lines, for example arranged to be guided by the outer conductor.

38. The base station according to claim 20, wherein the at least one electrically conductive antenna element is connected, directly or indirectly, to at least one of the air-filled coaxial lines of the first group and/or the at least one electrically conductive antenna element is connected, directly or indirectly, to at least one of the air-filled coaxial lines of the second group.
